(19) United States
(12) Patent Application Publication
(10) Pub. No.: US 2004/0161327 A1
(43) Pub. Date: Aug. 19, 2004

(54) Forklift with impact cushion

(76) Inventors: Maurice M. Paxton, Atlanta, GA (US); Terry C. Harris, Ranger, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/775,352

(22) Filed: Feb. 10, 2004

Related U.S. Application Data
(60) Provisional application No. 60/446,193, filed on Feb. 10, 2003.

(51) Int. Cl. B66C 3/00

(52) U.S. Cl. 414/785

(57) ABSTRACT

Impact cushions are mounted to the upright arms of the mast at the horizontal lifting arms of a fork lift truck. The cushions are molded monolithic bodies, each having a flat mounting surface for engagement with the upright arm of the mast, a semi-cylindrical load engaging surface opposed to the flat mounting surface for engaging pallets and/or loads carried by the fork, and parallel flanges straddling the flat mounting surface for aligning the mounting surface to the mast.

### CROSS REFERENCE TO RELATED APPLICATION

This application claims the benefit of U.S. Provisional Patent Application No. 60/446,193, filed in the U.S. Patent and Trademark Office on Feb. 10, 2003.

### FIELD OF THE INVENTION

This invention involves impact cushions for forklift trucks that have a pair of L-shaped lifting forks, with each fork having a horizontal lifting arm that is used to move beneath an object to be lifted and an upright mast that connects to the truck for being moved vertically by the truck. The impact cushions are mounted to the arms of the mast at the intersection of the mast and the horizontal lifting arms for cushioning against impact between the load and the mast.

### BACKGROUND OF THE INVENTION

Forklift trucks are used in many industries for the purpose of lifting heavy loads and transporting the loads to different areas. Typically, a product is mounted on a pallet that has an elevated platform on which the product rests, and the horizontal lifting arms of the forks of the forklift are inserted beneath the platform so as to reach into the pallet and beneath the load and have the ability to lift the load and its platform without damaging the product. Once the load is lifted by the horizontal lifting arms, it is conventional practice to tilt the mast of the fork so that the load tends to become inclined and partially rests against the mast of the fork. This tends to assure that the load will not fall off the front of the fork, particularly when the forklift truck is moving forward and is braked.

During the use of a forklift truck, it is not unusual for the fork of the truck to damage the product being handled, or to damage the pallet that supports the product. One of the most common instances of damage to the products and to the pallets occurs by impact by the mast of the fork engaging the product or pallet as the fork is moved into the pallet beneath the product. Another common instance of damage is when the product engages, under the influence of its own weight, against the mast of the fork during tilting movement of the mast or during the acceleration of the truck in a forward direction.

Typically, pallets on which loads are placed are re-used when the loads mounted on the pallets reach a delivery destination and the loads are removed from the pallets. The pallets receive subsequent loads and support these loads during their subsequent handling and delivery. This repeated use of the pallets results in the pallets being engaged many times by fork lifts. The repeated engagement of the pallets by fork lifts results in wear and damage to the pallets.

Because of the frequent damage to load carrying pallets, most pallets are fabricated inexpensively and the pallets are discarded after only a few uses.

When forklift trucks are used to handle loads that are not mounted on pallets, the mast of the forks can damage the goods. For example, when bags of granular products are being handled by a forklift truck, the bags tend to sag about the horizontal lifting arms and/or about the upright mast, and the angles of the mast and horizontal lifting arms where the sides and ends of the forks engage the bags tend to abrade, stretch, and otherwise deteriorate the material of the bags, occasionally causing leakage of the granular products from the bags. In other instances where the product is rigid, the impact or vibration between the product and the fork can cause scarring, scratching or other deterioration of the product.

It is to these problems that this invention is directed.

### SUMMARY OF THE INVENTION

Briefly described, the present invention involves impact cushions applied to the upright support arms of the mast of the L-shaped lifting bars that form the fork of a fork lift truck. Each impact cushion includes a load engaging surface that faces forwardly of the mast and a mounting surface opposed to the load engaging surface for connection to the upright support arm of the L-shaped lifting bar. In one embodiment adhesive may be applied between the mounting surface of the impact cushion and the upright support arm for connecting the cushion to the L-shaped lifting bar. In another embodiment of the invention mounting straps may be extended about both the cushion and the upright support arm for connecting the cushion to the upright support arm.

The impact cushions are molded and are formed of recycled rubber, with the recycled rubber being styrene butadiene, known as “SBR.” The recycled rubber is mixed with a polyurethane binder, specifically a single component polyurethane resin. The ratio of urethane to rubber can be modified so as to adjust the compressibility of the impact cushion, as may be desired. The impact cushion typically will be produced and delivered to the site of a forklift truck with adhesive applied to its mounting surface and a peel-away strip applied to the adhesive so as to preserve the adhesive until the impact cushion is physically mounted to an upright support arm of the L-shaped lifting bars.

The impact surface of the impact cushion can be of various configurations that would be compatible with the loads being handled.

Thus, it is an object of this invention to provide an improved impact cushion for the L-shaped lifting bars of a forklift truck, so as to reduce the likelihood of damage to products handled by the truck.

Another object of this invention is to provide an improved forklift truck having its L-shaped lifting bars protected by impact cushions so as to reduce the tendency of the lifting bars to damage products handled by the forklift truck.

Another object of this invention is to provide impact cushions for the fork of a forklift truck that are compatible in their configuration for expedient mounting to and adhesion to the L-shaped lifting bars of the forklift truck.

Other objects, features and advantages of the present invention will become apparent upon reading the following specification, when taken in conjunction with the accompanying drawings.

### BRIEF DESCRIPTION OF THE DRAWINGS

FIG. 1 is a perspective illustration of a forklift with the impact cushions installed on it.

FIG. 2 is a perspective illustration of one of the impact cushions.

FIG. 3 is a top view of the impact cushions of FIGS. 1 and 2.

FIG. 4 is a top view of a modified impact cushion.

FIG. 5 is a side cross sectional view of the lower end portion of an impact cushion, expanded away from the L-shaped lifting bar to which it is to be mounted, as shown by the dash lines.

FIG. 6 is a perspective view of the impact cushion of FIG. 2, but showing how the adhesive is exposed just prior to attachment of the impact cushion to the forklift truck.

FIG. 7 is a schematic illustration of how the forks of a forklift truck are advanced into engagement with a palletized load.

FIG. 8 is a schematic illustration, similar to FIG. 7, but showing the forklift and its palletized load being tilted.

### DETAILED DESCRIPTION

Referring now in more detail to the drawings in which like numerals indicate like parts throughout the several views, FIG. 1 illustrates a forklift truck 10 that is equipped with impact cushions. The forklift truck includes a pair of L-shaped lifting bars 11 that are of conventional design and which are mounted to the front of the truck 10 in a standard manner. Each L-shaped lifting bar includes a horizontal lifting arm 14 and an upright support arm 16. The horizontal lifting arm 14 and the upright support arm 16 are joined at intersection 18 as shown in FIG. 5. This is standard in the prior art.

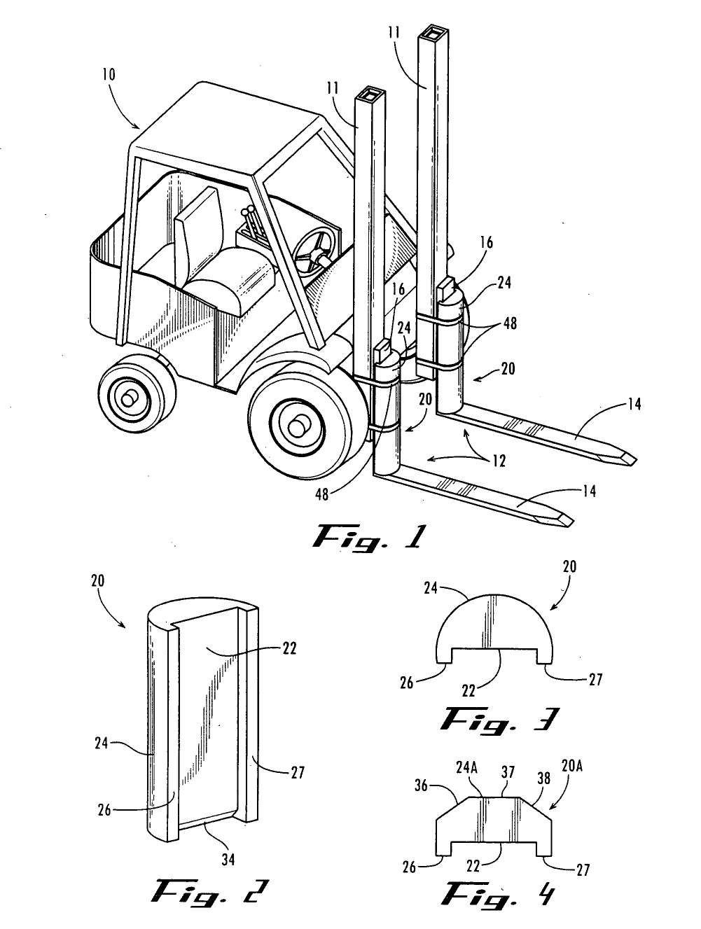

Impact cushions 20 are mounted to the pair of L-shaped lifting bars 11 as shown in FIG. 1. As shown in FIGS. 2-4, the cushions 20 include a substantially flat mounting surface 22, and opposing load-engaging surface 24 and a pair of parallel positioning flanges 26 and 27 that straddle the flat mounting surface 22.

As illustrated in FIG. 6, adhesive 28 may be applied to the flat mounting surface 22 and a peel-away strip 30 temporarily covers the adhesive when the impact cushion 20 has been produced but has not yet been applied to the upright support arms 16 of the forklift truck.

As illustrated in FIGS. 1 and 5, the bottom surface 32 of the impact cushion 20 is positioned so that it abuts and rests upon the upper surface 15 of the horizontal lifting arm 14 of the L-shaped lifting bar 12. The portion of the bottom surface 32 of the impact cushion is beveled at 34 at an angle that avoids obstructive engagement with the inside of the intersection 18 between the horizontal lifting arm 14 and the upright support arm 16 of the L-shaped lifting bars 12. This allows the bottom surface 32 to rest flush against the upper surface 15 of the horizontal lifting arm 14.

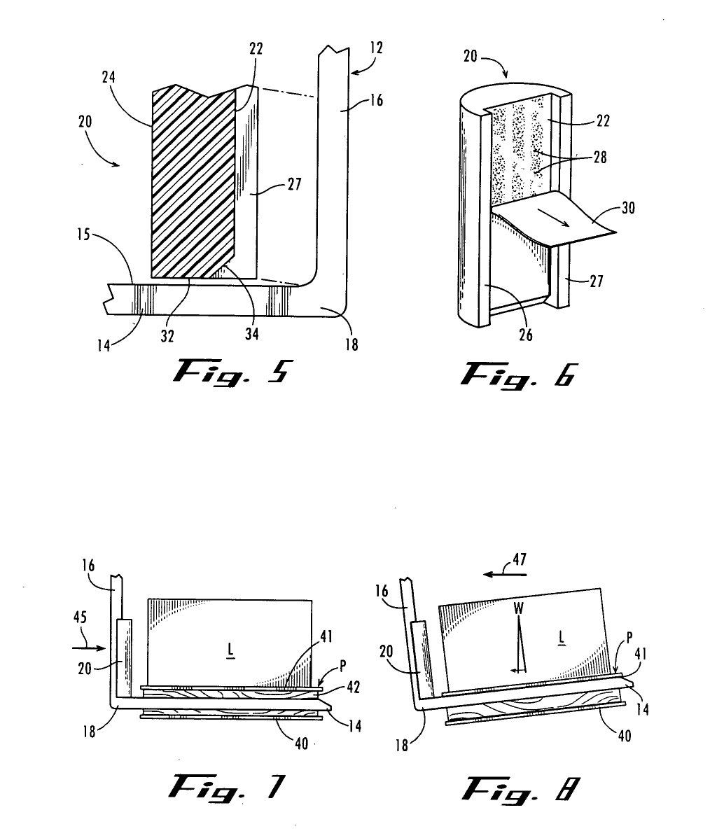

FIG. 4 shows a modified impact cushion 20A that includes a load engaging surface 24A of a different shape. The load engaging shape 24 of FIGS. 1-3 is semi-cylindrical, whereas the load engaging shape 24A of FIG. 4 is formed of flat surfaces 36, 37 and 38. The semi-cylindrical surface 24 is suitable for most anticipated functions, in that it provides an impact surface that is compatible with the shapes of most loads to be carried by the forklift truck 10. For example, due to its compressibility, the semi-cylindrical load engaging surface 24 will tend to conform to the hard surfaces forced against it, such as boxes filled with foods, or the edges of pallets on which the products are loaded. In addition, the flexible items, such as bags filled with particulate matter, such as seeds or nuts, tend to conform somewhat to the convex shape of the impact cushions, thereby tending to avoid abrasion or tearing of the bags as when engaged by relatively sharp edges of the upright support arm of a forklift.

FIG. 7 illustrates a load L mounted on a pallet P. The pallet is of conventional construction, including a bottom platform 40, an upper platform 41, with vertical spacers 42 extending between the platforms and holding them apart so as to form the fork receiving space between the platforms 40 and 41. The horizontal lifting arm 14 of the forklift is moved in the direction as indicated by arrow 45 until the horizontal lifting arm 14 is fully received beneath the load L. In most instances, the impact cushions 20 that are mounted to the lower portion of the upright support arm 16 will engage against the upper platform 41 of the pallet and possibly against the load L. The impact cushions 20 usually flex in response to the impact applied to them by the pallet and the load.

As illustrated in FIG. 8, when the forks of the forklift truck are tilted, the weight of the load L tends to urge the load and the pallet P toward the upright support arm 16 and the impact cushion 20 as indicated by direction arrow 47. Again, there is a likelihood that the upper platform 41 of the pallet and the load L will engage against the impact cushions 20, and again the cushions 20 tend to conform to the shapes that are in engagement with them.

It will be understood that if the impact cushions 20 were not present on the upright support arm 16 as described herein, the upper platform 41 of the pallet P and the load L would likely engage the hard surface of the upright support arms 16, creating the hazard of damage to these items. Therefore, it will be understood that the impact cushions 20 tend to reduce the damage to the pallets and to the loads carried by the forklift truck.

When the impact cushions 20 are to be applied to the upright support arms 16, the peel-away strip 30 is removed from the flat mounted surface 22, thereby exposing the previously applied adhesive 28. The positioning flanges 26 and 27 are placed in a straddling relationship with respect to the upright support arms 16, and the bottom surfaces 32 of the cushions are placed in engagement with the horizontal lifting arms 14, so that the cushion becomes seated at the intersection 18 of the pair of L-shaped lifting bars 12. This causes the cushion to be supported by the horizontal lifting arm 14 and places the cushion at a low position with respect to the L-shaped lifting bars 12 so as to be properly positioned for receiving impacts from the upper platform 41 of the pallets P.

The impact cushions can be of different heights, depending upon the anticipated loads to be handled by the forklift truck. The cushions can be made longer so that they reach higher on the upright support arms 16 in those instances where the loads are high and likely to move into engagement with the upright support arms. Or an additional cushion can be stacked on top of the lower cushion.

The placement of the impact cushions 20 so low on the pair of L-shaped lifting bars 12 assures that impact protection will be provided not only to the load carried by the pallet, but to the pallet as well. This tends to prolong the life of the pallets used with the forklift truck of this invention.

The impact cushions can be formed of various materials, depending upon the loads to be carried by the forklift truck and the desired lifetime of the impact cushions. Preferably, the impact cushions can be made of recycled rubber from tires of automobiles, trucks and airplanes. The recycled rubber is styrene butadiene, sometimes known as “SBR.” The rubber from the recycled tires is received in a particulate form with screen meshes of minus 16, plus 40, so that the minus 16 provides the particulate material through a 16 mesh screen, and the material cannot pass through a 40 mesh screen. The particulate rubber is mixed with a binder, such as polyurethane. When using polyurethane as the binder, the ratio of binder to rubber is 12% to 88% for a preferred embodiment. The compression resistance of the impact cushion can be changed by changing the binder, and an acceptable range for the impact cushion is from 5% to 20% binder, with the most preferred range being from 8% to 14% binder. When increased abrasion resistance is desired, more binder can be used.

The rubber and binder are mixed and placed in a mold, heated and cured, with the resulting product being monolithic, in the shapes illustrated in the drawings.

While the adhesive has been disclosed as being placed on the flat mounting surface 22, the impact cushion can be provided without adhesive, and the adhesive can be applied at the site where the impact cushion is to be mounted to the upright support arm 16. When the impact cushions are to be applied to the upright support arms 16, the positioning flanges 26 and 27 are placed in a straddling relationship with respect to the upright support arm, so that the impact cushion is positioned properly laterally, and the bottom surface 32 is placed upon the upper surface 15 of the horizontal lifting arm 14. The positioning flanges not only assist in properly locating the impact cushion when first being installed, but also tend to continue to hold the impact cushion in place about the sides of the upright support arm 16, and the positioning flanges assist in avoiding direct contact between the load and the sides of the upright support arms 16.

As shown in FIG. 1, in addition to or instead of the use of adhesive to hold the cushions to the upright support arms 16, straps 48 may be extended about the cushions and the upright support arms to hold the cushions in place.

Although a preferred embodiment of the invention has been disclosed in detail herein, it will be obvious to those skilled in the art that variations and modifications of the disclosed embodiment can be made without departing from the spirit and scope of the invention as set forth in the following claims.

1. An impact cushion for a forklift truck of the type having a pair of L-shaped lifting bars that together form a fork, each said lifting bars having a horizontal lifting arm that is used to move beneath an object to be lifted and an upright support arm that is connected to the truck for being moved vertically by the truck, said impact cushion applied to said upright support arm, said cushion comprising:
a load engaging surface,
a mounting surface opposite said load engaging surface for connection to the upright support arm of an L-shaped lifting bar,
adhesive applied to said mounting surface of said cushion, and
protective peel away sheet material applied to the adhesive,
so that the sheet material can be removed from the mounting surface of the cushion and the mounting surface applied to the upright mounting arm of the lifting bar and the parallel flanges straddle the upright mounting arm of the lifting bar.

2. The impact cushion of claim 1, wherein said cushion is monolithic.

3. The impact cushion of claim 1, wherein said cushion is formed of rubber.

4. The impact cushion of claim 1, wherein said cushion has a bottom surface and a bevel extending between said bottom surface and said mounting surface to accommodate the shape of the intersection between the horizontal lifting arm and the upright support arm of an L-shaped lifting bar.

5. The impact cushion of claim 1 and wherein said load engaging surface is semi-cylindrical.

6. The impact cushion of claim 1, wherein said mounting surface is flat, and said load engaging surface includes a flat surface parallel to said mounting surface.

7. The impact cushion of claim 1, wherein said cushion is formed of styrene butadiene.

8. The impact cushion of claim 1, wherein said cushion is formed of particulate rubber of a screen mesh from minus 16 and plus 40, and from 5% to 20% by weight binder.

9. The impact cushion of claim 1, wherein said cushion further includes parallel flanges straddling said mounting surface for positioning on opposite sides of the upright mounting arm of an L-shaped lifting bar.

10. The impact cushion of claim 9, and further including straps extending about the load engaging surface and the parallel flanges of the cushions and about the upright support arms configured to hold the cushions in place on the upright support arms.

11. An impact cushion for a forklift truck, the fork lift truck having a pair of lifting bars for lifting and transporting loads, the lifting bars each including a horizontal lifting arm that is used to move beneath an object to be lifted and an upright support arm that is connected to the truck for being moved vertically by the truck, said impact cushion comprising:
a molded monolithic body including:
a semi cylindrical load engaging surface,
an elongated flat mounting surface opposite said load engaging surface of a breadth that matches the breadth of the upright support arm of the fork lift truck for mounting said body to the upright support arm and orienting said semi-cylindrical load engaging surface over the horizontal lifting bars,
a bottom surface for engagement with and resting on the horizontal lifting arm, and
means holding said mounting surface of said cushion in alignment with the upright support arm of said L-shaped lifting bar with the bottom surface of said cushion in engagement with the horizontal lifting arm,
so that the impact cushion is positioned to absorb impacts from pallets and from loads to be carried by the lifting bars.

12. The combination of claim 11, wherein said means holding said mounting surface of said cushion in alignment with the upright support arm comprises parallel flanges straddling said mounting surface for positioning on opposite sides of one of said upright mounting arms of one of said L-shaped lifting bars.

13. The combination of claim 11, wherein said impact cushions each include a lower surface extending between said impact surface and said mounting surface, said lower surface configured for resting on the horizontal lifting arm of the lifting bar.

14. The combination of claim 11, wherein said cushions are each formed of particulate recycled rubber of screen meshes of minus 16, plus 40, and formed in a monolith with from 5% to 20% binder.

15. The combination of claim 11, wherein said load engaging surface of at least one of said cushions is semi-cylindrical.

16. The combination of claim 11, wherein said load engaging surface of at least one of said cushions is flat and parallel to said mounting surface for flat engagement with a load carried by the fork lift truck.
